(19) United States
(12) Patent Application Publication
(10) Pub. No.: US 2008/0258470 A1
(43) Pub. Date: Oct. 23, 2008

(54) Energy Generation System For Housing, Commercial, and Industrial Applications

(76) Inventors: Soon Eng Khoo, Alameda, CA (US); Gary E. Phillippe, North Highlands, CA (US)

Correspondence Address: COURTNEY STANIFORD & GREGORY LLP, P.O. BOX 9686, SAN JOSE, CA, 95157, US

(21) Appl. No.: 12/102,708

(22) Filed: Apr. 14, 2008

Related U.S. Application Data
(60) Provisional application No. 60/923,223, filed on Apr. 12, 2007.

(51) Int. Cl. F02B 63/04; F03B 13/00; F03D 9/00

(52) U.S. Cl. 290/1 A; 290/54; 290/55

(57) ABSTRACT

Embodiments of a system for providing energy to a house or group of houses comprising an energy source coupled to a motor, generator, storage battery, and control/monitoring unit, are described. A plurality of different energy sources can be used in conjunction with a power control and generation system that comprises an input interface coupled to a high-efficiency generator and an output interface to either an energy storage unit or output to a power grid. The different energy sources can include solar, wind or water power, compressed gas or internal combustion engine power, or electrical power. For non-kinetic energy sources, a motor may be included as part of the power control and generation system. The input interface of the power control and generation system includes a power conditioning module for optimizing the operating range of the motor. The high efficiency generator outputs AC electricity at a relatively high frequency. The output interface down converts this AC power to standard power grid frequencies.

### CROSS-REFERENCE TO RELATED APPLICATIONS

The present application claims the benefit of the U.S. Provisional Application No. 60/923,223 entitled “Energy Generation System for Housing Applications,” and filed on Apr. 12, 2007.

### FIELD

Embodiments of the invention relate generally to energy generation, and specifically to regenerative energy systems for housing and industrial applications.

### BACKGROUND

Standard energy systems for houses in industrialized areas typically utilize electricity provided by a municipal power grid. Supplemental energy in the form of gas, heating oil, propane and similar combustion sources can be used to power certain aspects of home needs, such as stoves and heating systems, and can also be used to supplement the electrical supply. In many non-industrialized, power grids are non-existent and electrical energy is not available to provide the necessary power for houses. In these areas, other sources of energy must be used.

With increasing oil and energy prices, and concern over the creation of greenhouse gases, there is a much greater need for increased efficiency and alternative fuel sources. For housing applications, various non-polluting energy sources have been developed, such as solar or wind powered systems. Such systems however have not attained any degree of sustained success due to disadvantages, such as installation and maintenance costs and vulnerability to environmental conditions. Such systems also cannot often provide the necessary power to run a typical size house (e.g., 3-4 bedroom house) with an average number of active appliances during peak, or even normal load periods. Moreover, most renewable, such solar and wind power generate peak power during times when demand is relatively, such as mid-day for solar, or midnight for wind. However, during peak demand times, these sources may not be sufficient by themselves. What is needed, therefore, is a power generation system that supplements and makes more efficient the provision of power from renewable energy sources, and other grid tie-in systems that are inadequate, and where blackouts and brownouts may be common.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates an energy generation system for houses, buildings, large vehicles or other similar industrial structures that have significant energy requirements.

FIG. 2 illustrates a power generation system for converting solar energy into electrical energy for use in a housing application, under an embodiment.

FIG. 3 illustrates a power generation system for converting wind or water kinetic energy into electrical energy for use in a housing application, under an embodiment.

FIG. 4 illustrates a power generation system for converting power from a compressed natural gas source into electrical energy for use in a housing application, under an embodiment.

FIG. 5 illustrates a power generation system for converting power from an internal combustion engine into electrical energy for use in a housing application, under an embodiment.

FIG. 6 illustrates a power generation system for conditioning electrical energy for use in a housing application, under an embodiment.

FIG. 7 illustrates a representative power curve for a 5 horsepower, gas-powered generator for use in a power generation system, according to embodiments.

FIG. 8A illustrates regulation of input voltage to an induction motor in a power generation system, according to embodiments.

FIG. 8B illustrates regulation of input current to an induction motor in a power generation system, according to embodiments.

### DETAILED DESCRIPTION

Embodiments of a high-efficiency energy generation system for housing applications are described. A plurality of different energy sources can be used in conjunction with a power control and generation system that comprises an input interface coupled to a high-efficiency generator and an output interface to either an energy storage unit or output to a power grid. The different energy sources can include solar, wind or water power, compressed gas or internal combustion engine power, or electrical power. For non-kinetic energy sources, a motor may be included as part of the power control and generation system. The input interface of the power control and generation system includes a power conditioning module for optimizing the operating range of the motor. The high efficiency generator outputs AC electricity at a relatively high frequency. The output interface down converts this AC power to standard power grid frequencies.

Although embodiments are described in relation to particular components or method steps, one skilled in the relevant art will recognize that these described embodiments can be practiced without one or more of the specific details, or with other components, systems, and so on. In other instances, well-known structures or operations are not shown, or are not described in detail, to avoid obscuring aspects of the disclosed embodiments.

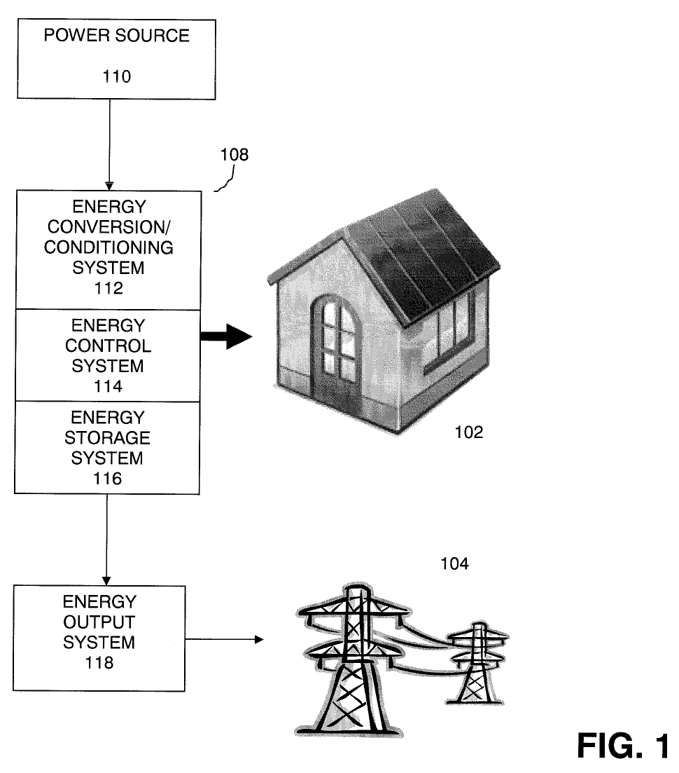

FIG. 1 illustrates an energy generation system for houses, buildings, housing tracts, compounds, large vehicles or other similar industrial structures that have significant energy requirements. A power source 110 is coupled to an energy generation system that comprises an energy conversion/conditioning system 112, and energy control system 114 and an energy storage system 116. These components may be implemented within a single unitary module, or they may be implemented within separate components that can be coupled to one another through appropriate physical, electrical and logical interfaces. One or more of the components may be physically located within the house 102 or building for which energy is being supplied. The energy generation system 108 takes as input power from the power source 110 and provides electricity to house 102. Some or all of the electricity produced by power generation unit 108 is used to power the appliances and other electrical devices in the house, and any appropriate surrounding areas. The electrical energy may also be stored in the energy storage system 116. If any excess electricity is produced, that is, electricity in surplus of operating and/or storage needs, it can be provided to the municipal electrical grid 104 or other users.

The power source 110 may be any one of the following sources: (1) solar energy, which is any power or energy from the sun, direct or indirect sunlight or equivalent light sources utilizing solar panels, solar mirrors or solar absorbent material that changes this light into electric energy; (2) wind/water energy, which is any power or energy from wind, wind movement, water, or other similar natural kinetic energy utilizing wind turbines, wind capturing device, water mills, and similar devices; (3) compressed gas energy, which is any kinetic, heat or chemical power or energy from compressed gas sources, including compressed gas in tanks, pipes, and tankers; (4) internal combustion engines, which is any power or energy from the combustion of chemicals, steam, petroleum-based fuels, man-made synthetic fuels, organic fuels, such as gasoline, diesel, ethanol, hydrogen, liquid natural gas, bio-fuels, hydrocarbon fuel in any normally or non-normally aspirated internal combustion engine; and (5) electrical energy, which is electrical power or energy from any source such as an electrical generator, storage source, electrical power grid, and the like.

For the embodiment of FIG. 1, the energy conversion/conditioning system can be any type of circuit that accepts the energy from the energy source and converts it to electrical energy required by the house, such as 120V, 60 (or 50) cycle AC power, and so on. Depending upon the power source, the energy conditioning system includes an interface that receives the energy from the power source and converts it depending upon implementation constraints and requirements. The interface may be any one of the following devices, either alone or in combination: (i) a switch; (ii) an inverter; (iii) a coupling; (iv) a connector; (v) a torque converter; (vi) a transmission; (vii) a continuously variable transmission; (viii) a pressure regulator; (ix) a controlling device; (x) an electronic power controlling/conditioning device; (xi) a computer; (xii) a microchip; (xiii) a turbine device; and (xiv) an electrical source.

The energy control system, in one embodiment comprises a computer controlled system that monitors the input energy from the power source and the converter and conditions the electrical energy for use by the house. One or more metering functions are used to meter the input energy and route the energy accordingly depending upon the needs of the appliances, users, and devices within the house. The control system 114 also routes energy as required or available to the energy storage device. The control system 114 can also route surplus energy to external users, such as the power grid or other users.

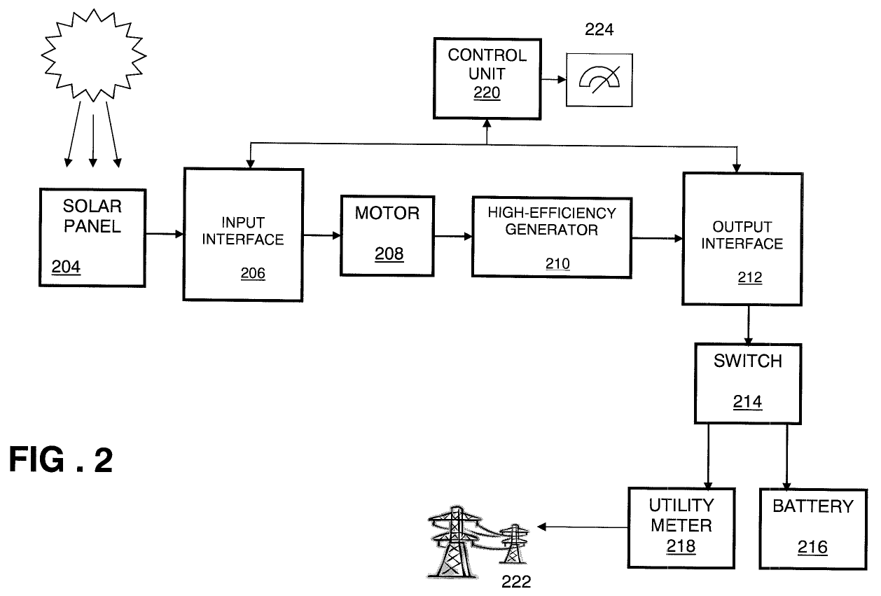

FIG. 2 illustrates a power generation system for converting solar energy into electrical energy for use in a housing application, under an embodiment. For the embodiment illustrated in FIG. 2, the solar energy source (e.g., the sun) provides energy to solar panel array 204, which consists of photovoltaic cells that convert sunlight into DC electricity. The solar array 204 is coupled to an input interface 206, which includes an inverter circuit that converts the DC power from the solar panel array into AC power. The input interface 206 is coupled to a motor 208. In one embodiment, the motor is a small, portable electric induction motor that provides an output on the order of 5-7 horsepower, although smaller or larger motors with smaller or greater output are can also be used. The motor 208 takes the AC electrical power from the inverter stage of the input interface 206 and produces mechanical (rotational) energy through its output shaft. The motor is coupled to a high-efficiency generator 210, which converts the mechanical energy of motor 208 into electrical energy through electromagnetic induction processes. The generator 210 features an efficiency on the order of 85% or greater, and outputs AC power at a specific frequency, e.g., 30 Khz. In an alternative embodiment, motor 208 can be direct current motor, in which case, inverter stage of input interface 206 is not required.

As shown in FIG. 2, the generator output is taken through an output interface 212 to a switch 214. The output interface includes an inverter that conditions the output energy from the output generator 210. The switch routes any surplus energy to a battery 216 or to a utility meter 218 for transmission to external users, such as the power grid 222. As shown in FIG. 2, a single control unit 220 and metering system 224 can be coupled to both the input interface 206 and output interface 208. Alternatively, each interface can have its own control unit and metering system.

In one embodiment, the switch 214 is configured to route power from the output interface 212 to different appliances of different current type inputs, i.e., either DC or AC, as well to route surplus energy to battery 216 and/or utility meter 218. For this embodiment, switch 214 contains logic to determine the current type of any attached device and provide power accordingly. Alternatively, switch 214 may be coupled to control unit 220, which determines the current type and sends an appropriate signal to switch 214 to route the appropriate power to the proper device.

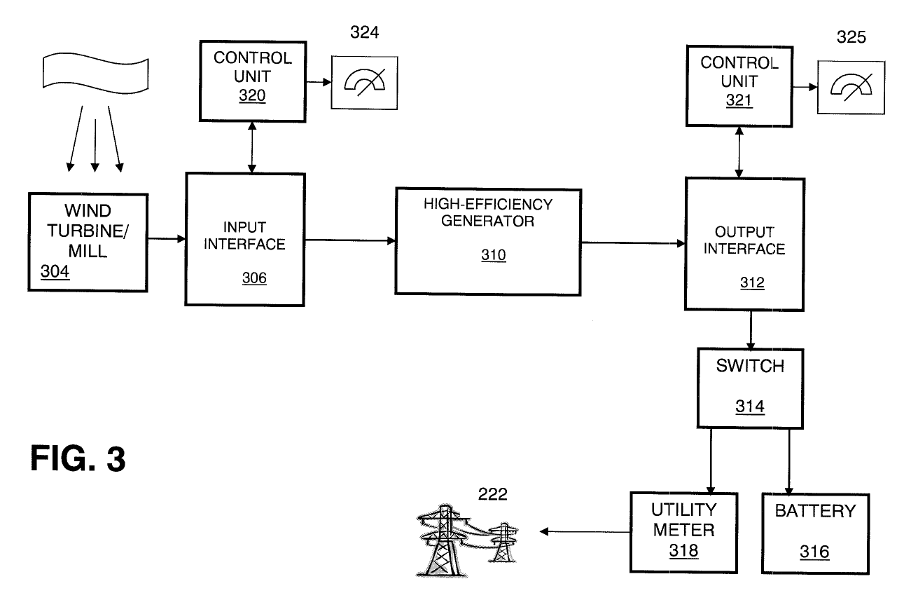

The power generation system of FIG. 2 generally provides benefits over traditional solar power systems by improving the efficiency and quality (in terms of voltage versus current) of the electrical generation system and maximizing the amount of solar power from the panels that is available to power any devices in the output stage of the system. Traditional solar power systems typically comprise a solar cell array coupled to an inverter, which then feeds directly to an output stage consisting of devices to be powered, or a battery storage system for off-grid power supply applications, or a power grid for grid tie-in power supply applications. The power generation system illustrated in FIG. 2 and consisting of the input/output interfaces, motor and generator increase the overall efficiency of the system by conditioning the electrical power provided by the power source and providing interactive control through control unit 220 to ensure that use and conversion of input power is optimum for all output load conditions. Similar benefits are provided for other power supply implementations, such as illustrated in FIGS. 3-6.

FIG. 3 illustrates a power generation system for converting wind or water kinetic energy into electrical energy for use in a housing application, under an embodiment. For the embodiment illustrated in FIG. 3, the wind or water energy provides kinetic energy that drives a turbine, windmill, watermill, or similar device 304. In general, the turbine or mill 304 provides rotational energy through a driveshaft. This output is fed through input interface 306, which can be any type of mechanical interface, such as a transmission or gearing system. The input interface is coupled to a high-efficiency generator 310, which converts the mechanical energy of turbine/mill 304 into electrical energy through electromagnetic induction processes. The generator 310 features an efficiency on the order of 85% or greater, and outputs AC power at a specific frequency, e.g., 30 Khz. The generator output is taken through an output interface 312 to a switch 314. The output interface includes an inverter that conditions the output energy from the output generator 310. The switch routes any surplus energy to a battery 316 or to a utility meter 318 for transmission to external users, such as the power grid 222. In one embodiment, the switch 314 is configured to route power from the output interface 312 to different appliances of different current type inputs, i.e., either DC or AC, as well to route surplus energy to battery 316 and/or utility meter 318. For this embodiment, switch 314 contains logic to determine the current type of any attached device and provide power accordingly. Alternatively, switch 314 may be coupled to control unit 320, which determines the current type and sends an appropriate signal to switch 314 to route the appropriate power to the proper device. As shown in FIG. 3, a control unit 320 and metering system 324 is coupled to the input interface 306, and a separate control unit 321 and metering system 325 is coupled to the output interface 312. Alternatively, a single control unit and metering system could be coupled to both the input interface 306 and output interface 308.

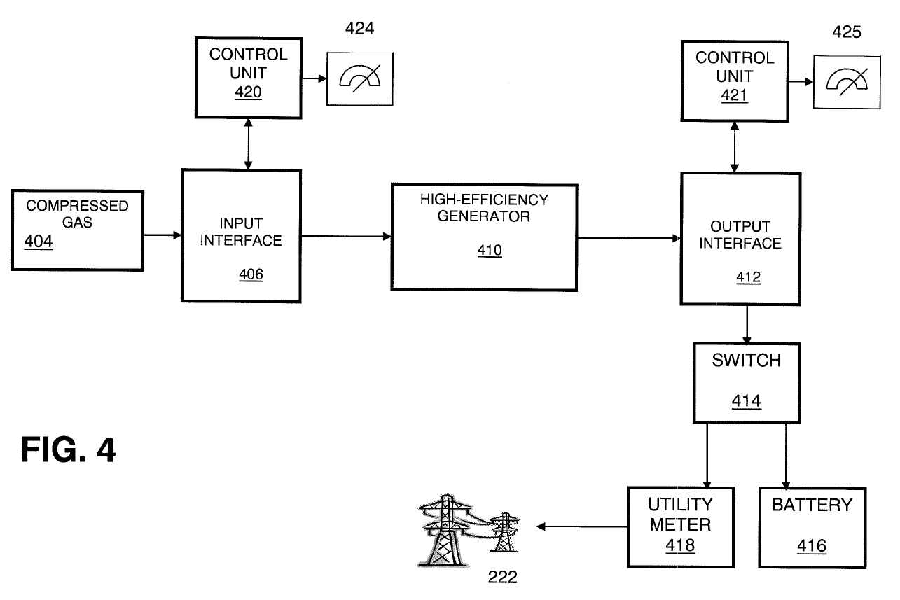

FIG. 4 illustrates a power generation system for converting power from a compressed natural gas source into electrical energy for use in a housing application, under an embodiment. For the embodiment illustrated in FIG. 4, a compressed gas source 404 provides kinetic energy in the form of pressure. This source is coupled through input interface 306, which can be any type of mechanical interface that can convert the pressure energy of source 404 into mechanical energy suitable to drive the high efficiency generator 410. The high-efficiency generator 410 converts the mechanical energy of compressed gas source 404 into electrical energy through electromagnetic induction processes. The generator 410 features an efficiency on the order of 85% or greater, and outputs AC power at a specific frequency, e.g., 30 Khz. The generator output is taken through an output interface 412 to a switch 414. The output interface includes an inverter that conditions the output energy from the output generator 410. The switch routes any surplus energy to a battery 416 or to a utility meter 418 for transmission to external users, such as the power grid 222. In one embodiment, the switch 414 is configured to route power from the output interface 412 to different appliances of different current type inputs, i.e., either DC or AC, as well to route surplus energy to battery 416 and/or utility meter 418. For this embodiment, switch 414 contains logic to determine the current type of any attached device and provide power accordingly. Alternatively, switch 414 may be coupled to control unit 420, which determines the current type and sends an appropriate signal to switch 414 to route the appropriate power to the proper device. As shown in FIG. 4, a control unit 420 and metering system 424 is coupled to the input interface 406, and a separate control unit 421 and metering system 425 is coupled to the output interface 412. Alternatively, a single control unit and metering system could be coupled to both the input interface 406 and output interface 408.

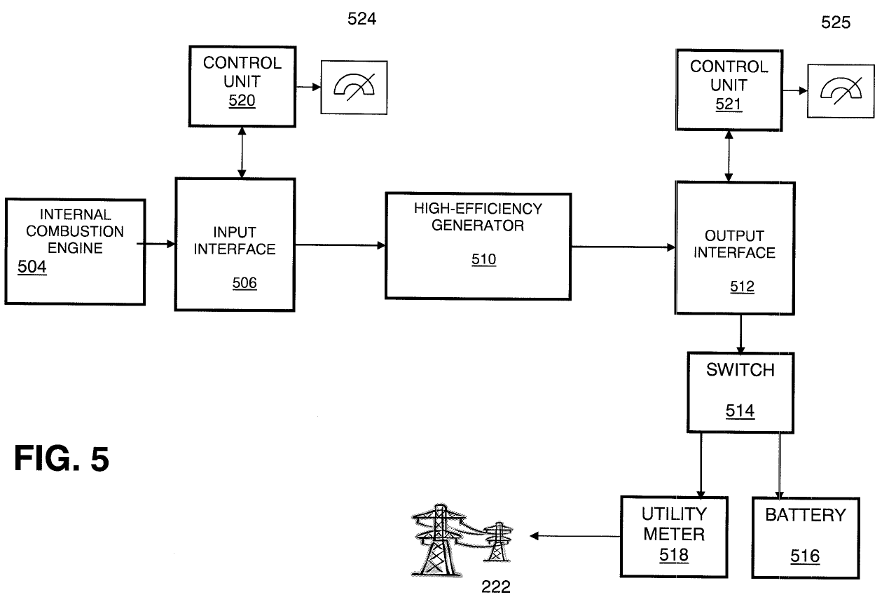

FIG. 5 illustrates a power generation system for converting power from an internal combustion engine into electrical energy for use in a housing application, under an embodiment. For the embodiment illustrated in FIG. 5, internal combustion engine 504 burns fuel (e.g., gasoline, diesel, propane, hydrogen, biofuel, etc.) to provides rotational energy through a driveshaft. This output is fed through input interface 506, which can be any type of mechanical interface, such as a transmission or gearing system. The input interface is coupled to a high-efficiency generator 510, which converts the mechanical energy of engine 504 into electrical energy through electromagnetic induction processes. The generator 510 features an efficiency on the order of 85% or greater, and outputs AC power at a specific frequency, e.g., 30 Khz. The generator output is taken through an output interface 512 to a switch 514. The output interface includes an inverter that conditions the output energy from the output generator 510. The switch routes any surplus energy to a battery 516 or to a utility meter 518 for transmission to external users, such as the power grid 222. In one embodiment, the switch 514 is configured to route power from the output interface 512 to different appliances of different current type inputs, i.e., either DC or AC, as well to route surplus energy to battery 516 and/or utility meter 518. For this embodiment, switch 514 contains logic to determine the current type of any attached device and provide power accordingly. Alternatively, switch 514 may be coupled to control unit 520, which determines the current type and sends an appropriate signal to switch 514 to route the appropriate power to the proper device. As shown in FIG. 5, a control unit 520 and metering system 524 is coupled to the input interface 506, and a separate control unit 521 and metering system 525 is coupled to the output interface 512. Alternatively, a single control unit and metering system could be coupled to both the input interface 506 and output interface 508.

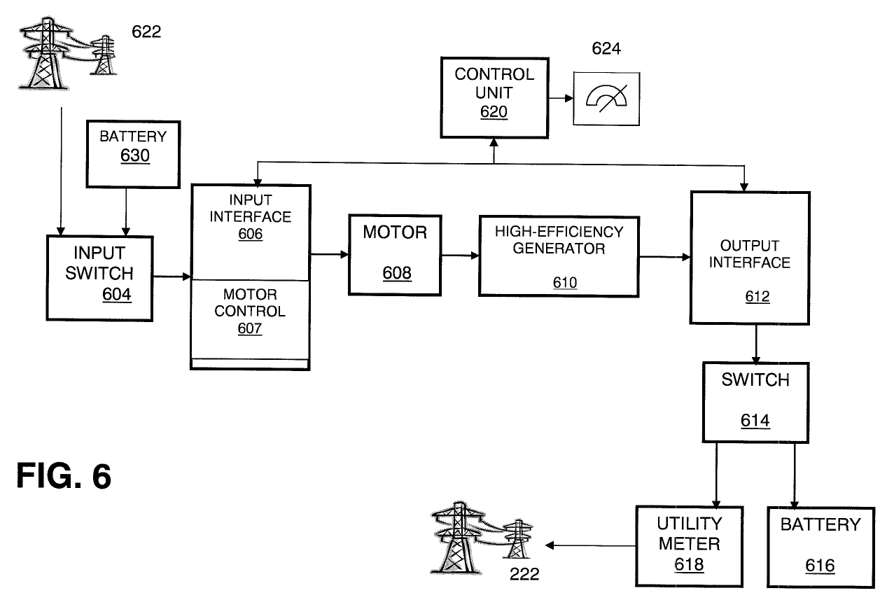

FIG. 6 illustrates a power generation system for conditioning electrical energy for use in a housing application, under an embodiment. For the embodiment of FIG. 6, the input power is electrical energy that can be provided by a number of different sources, such as battery 630 or a municipal or local power grid 604. The power sources are input into a switch 604 that selects which electrical source to use. The electrical sources are coupled through switch 604 to an input interface 606, which includes an inverter circuit that converts the DC power from any DC power source into AC power. If the power provided by the source is already AC, then no conversion is necessary. The input interface 606 is coupled to a motor 608. In one embodiment, the motor is a small, portable electric motor that provides an output on the order of 5 horsepower, although smaller or larger motors with smaller or greater output are can also be used. The motor 608 takes the AC electrical power from the inverter stage of the input interface 606 and produces mechanical energy through its output shaft. As shown in FIG. 6, the input interface 606 includes a motor control component 607 that controls the motor 608 to produce power within its optimum operating range to maximize output from the motor. The motor is coupled to a high-efficiency generator 610, which converts the mechanical energy of motor 608 into electrical energy through electromagnetic induction processes. The generator 610 features an efficiency on the order of 85% or greater, and outputs AC power at a specific frequency, e.g., 30 Khz.

As shown in FIG. 6, the generator output is taken through an output interface 612 to a switch 614. The output interface includes an inverter that conditions the output energy from the output generator 610. The switch routes any surplus energy to a battery 616 or to a utility meter 618 for transmission to external users, such as the power grid 222. In one embodiment, the switch 614 is configured to route power from the output interface 612 to different appliances of different current type inputs, i.e., either DC or AC, as well to route surplus energy to battery 616 and/or utility meter 618. For this embodiment, switch 614 contains logic to determine the current type of any attached device and provide power accordingly. Alternatively, switch 614 may be coupled to control unit 620, which determines the current type and sends an appropriate signal to switch 614 to route the appropriate power to the proper device. As shown in FIG. 6, a single control unit 620 and metering system 624 is coupled to both the input interface 606 and output interface 608. Alternatively, each interface can have its own control unit and metering system.

The power generation system of FIG. 6 effectively conditions the electrical power that is input into the system for use by devices on the output stage, and or for storage in battery 616 or output to power grid 222. The output interface 612 includes inverter circuitry that increases the voltage and decreases the current, which is favorable for certain applications. The control circuitry 620 conditions the power and performs load balancing for optimum delivery of power through varying output load conditions. The high-efficiency generator 610 produces AC power at relatively high frequencies, such as on the order of 30 KHz to 40 KHz. This high frequency is useful in certain applications, such as in lighting applications.

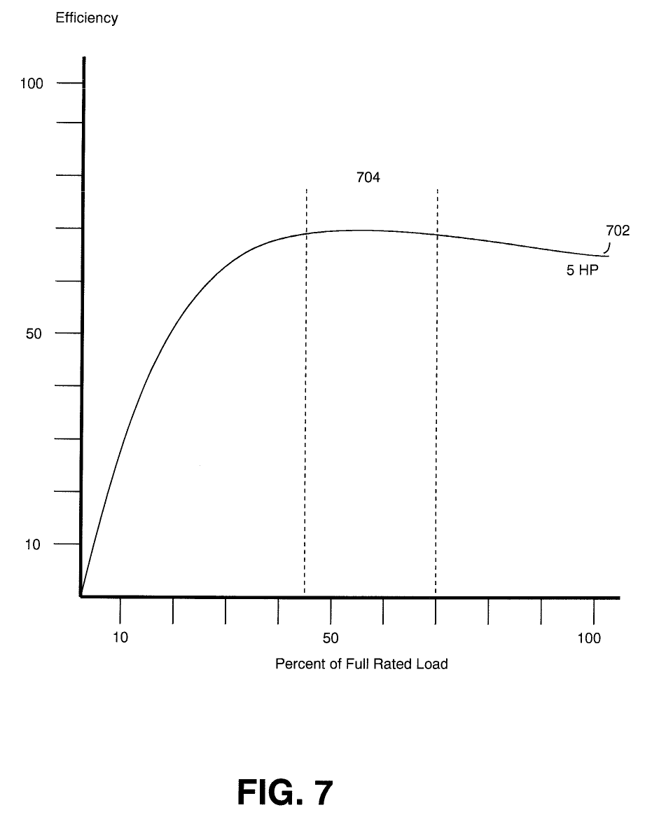

In one embodiment, the motor control component 607 of input interface 606 conditions the power applied to motor 608 so that the motor operates within its optimum power band. In general, AC induction motors typically operate below 100% efficiency, and the percentage of power varies depending upon several conditions. The efficiency of a motor is the ration of power delivered by the motor at the output shaft to the power delivered to the input terminals of the motor. That is, Efficiency=(useful power output)/(total power input). Typical AC motors operate most efficiently at around 75% of full rated load, with efficiency falling off at low and full load conditions. The efficiency curve for an example 5 HP AC induction motor is shown in FIG. 7. The efficiency is logged on the vertical axis of the graph, and the percentage of full rated load being driven by the motor is shown on the horizontal axis. As can be seen by efficiency curve 702, the efficiency of the example motor is very low at low load conditions and starts to peak around 45% load. This curve stays relatively flat until around 70-75% load when it starts to drop slightly. Thus, the motor shown in FIG. 7 is most efficient when it is operated at around 45% to 75% load. The motor control module 607 works in conjunction with the control unit 620, which is coupled to the output interface 612 to determine the load conditions for the generator 610. This information is then used to condition the power provided from the source through input interface 606 to ensure that the motor 608 is operating as often as possible within the optimum power band 704.

The motor control module 607 dynamically controls the voltage and current curves of the AC power provided by the inverter stage of the input interface 606. The control unit constantly monitors the power level and reduces or increases power to the motor so that it is constantly within the optimum load range 704. The motor controller 607 includes a voltage sensing and cutoff circuit that reduces the peak voltage delivered to the motor to maximize the energy efficiency at the input stage of the motor.

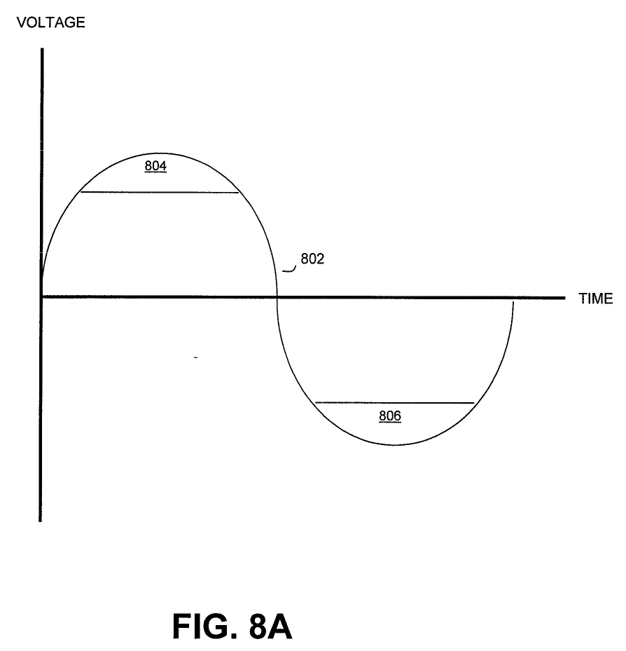

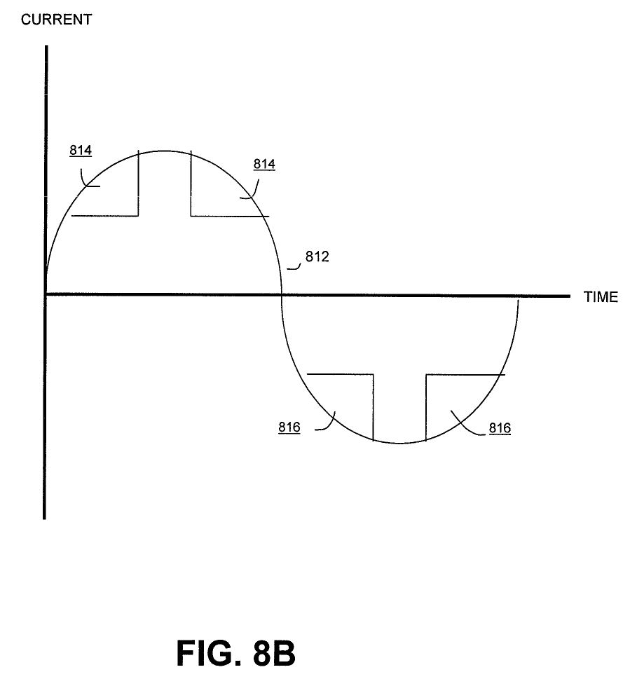

FIG. 8A illustrates regulation of input voltage to an induction motor in a power generation system, according to embodiments. As shown in FIG. 8A, sine curve 802 represents the voltage provided by the inverter stage of the input interface 606. The motor controller cuts off a portion of the maximum positive voltage swing and maximum negative voltage swing of the voltage curve 802. Region 804 represents the power saved during the positive cycle of sine wave 802 and region 806 represents the power saved during the negative cycle of the sine wave. The maximum voltage delivered to motor 608 is thus limited from the peak-to-peak value of the sine wave. The amount of cutoff as defined by the area of regions 804 and 806 is dynamically controlled by motor controller 607 based on the operating efficiency of motor 608.

FIG. 8B illustrates regulation of input current to an induction motor in a power generation system, according to embodiments. As shown in FIG. 8B, sine curve 812 represents the current provided by the inverter stage of the input interface 606. The motor controller cuts off a portion of the maximum positive current swing and maximum negative current swing of the current curve 812. The maximum peak-to-peak current is maintained by cutoff regions 814 defined on the positive cycle of sine wave 812 and cutoff regions 816 defined on the negative cycle of the sine wave. The maximum current delivered to the motor 608 thus corresponds to the peak current available, but an amount of power savings due to reducing the current by the regions 814 and 816 is realized through an overall reduction in current to the motor. The amount of cutoff as defined by area of regions 814 and 816 is dynamically controlled by motor controller 607 based on the operating efficiency of motor 608.

As shown in FIGS. 8A and 8B, the motor controller reduces the maximum range of the voltage swing and reduces the input current levels without reducing maximum current delivery. This effectively allows the input interface to reduce the power to motor so that it can be run at an optimum efficiency for any given load. This tailors the efficiency of the motor for a given load but consumes less power through reducing the usage input by the motor. Without such motor control, when the motor is run at low load conditions, it operating at much less than peak efficiency, yet the input power (Voltage*Current) remains constant. This results in a potentially great amount of power wastage. The motor controller 607 reduces the input power for low load conditions, thus resulting in substantial power savings and efficient motor operation by effectively shifting the input power to match the load conditions of the motor. The rate of change of voltage and current, and the relative change of voltage versus current is determined by motor controller 607 to dynamically conform to any changing conditions in the output stage of the power generation system.

As shown in FIG. 6, the mechanical output of motor 608 is input to high-efficiency generator 610. In one embodiment, the generator 610 is a three-stage generator that includes a rectifier stage that DC power output through three separate pairs of terminals. Each stage of the three-stages comprises a separate positive/negative output pair producing power through its own set of windings. Each stage is independent of the other two stages. Example power levels for such a generator are 100V to 450V output at 0.1 A to 50 A, but other power levels are possible. For this embodiment, the output interface 612 includes an inverter stage to convert this DC power into AC power for use by devices or appliances, or provision to the municipal power grid or storage. Examples of such inverters are 3.8 KW, 5 KW, 12 KW inverters such as made by Xantrex Technology Inc.

In an alternative embodiment, the generator 610 does not include a rectifier stage and outputs AC power at a relatively high frequency, such as 30 KHz. For this embodiment, the output interface 612 includes a converter stage to downconvert this high frequency power to the more standard 50 Hz or 60 Hz depending upon the environment in which the system is used.

Embodiments have been described with respect to certain discrete circuits or components. It should be noted that the terms “module,” “component,” “circuit,” or “element” may refer to a single unitary functional component or a distributed component that may be implemented in separate physical units. Moreover, such units may be embodied within hardware circuitry, programmable code executed by a processing unit, or a combination of hardware and software.

Aspects of the one or more embodiments, such as the control and monitoring systems described herein may be implemented on one or more computers or computing devices executing software instructions, either alone or over a network. The computers may be networked in a client-server arrangement or similar distributed computer network. In such a network, a network server may be coupled, directly or indirectly, to one or more network client computers through a network. The network interface between server computer and the client computers may include one or more routers that serve to buffer and route the data transmitted between the server and client computers. The network may be the Internet, a Wide Area Network (WAN), a Local Area Network (LAN), or any combination thereof.

Embodiments of the control system may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects of the control method include: microcontrollers with memory (such as EEPROM), embedded microprocessors, firmware, software, etc. Furthermore, aspects of the described system may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments is not intended to be exhaustive or to limit the embodiments to the precise form or instructions disclosed. While specific embodiments of, and examples for, the system are described herein for illustrative purposes, various equivalent modifications are possible within the scope of the described embodiments, as those skilled in the relevant art will recognize.

The elements and acts of the various embodiments described above can be combined to provide further embodiments. These and other changes can be made to the system in light of the above detailed description.

In general, in any following claims, the terms used should not be construed to limit the described system to the specific embodiments disclosed in the specification and the claims, but should be construed to include all operations or processes that operate under the claims. Accordingly, the described system is not limited by the disclosure, but instead the scope of the recited method is to be determined entirely by the claims.

While certain aspects of the system may be presented in certain claim forms (if claims are present), the inventor contemplates the various aspects of the methodology in any number of claim forms. For example, while only one aspect of the system is recited as embodied in machine-readable medium, other aspects may likewise be embodied in machine-readable medium.

What is claimed is:

1. A power generation system comprising:
an input interface receiving power from a power source;
an induction motor coupled to the input interface;
a high efficiency generator coupled to the induction motor;
an output interface coupled to the high efficiency generator; and
a control unit coupled to the input interface and the output interface.

2. The power generation system of claim 1 further comprising a switch coupled to the output interface, the switch configured to provide power output from the output interface to one or more of a plurality of output devices.

3. The power generation system of claim 2 wherein the output devices are selected from the group consisting of: electrical devices, battery storage elements, and a utility meter system for feeding a power grid.

4. The power generation system of claim 1 wherein the power source produces electrical energy.

5. The power generation system of claim 4 wherein the power source is selected from the group consisting of: solar power cells, municipal power grid electrical power, and stored electrical power.

6. The power generation system of claim 5 further comprising a switch coupled between the power source and the input interface to select a power source of a plurality of power sources coupled to inputs of the switch.

7. The power generation system of claim 1 wherein the input interface includes a motor control circuit configured to adjust the input power level to maintain operation of the induction motor to within an optimum efficiency range for a variable amount of output load on the motor.

8. The power generation system of claim 7 wherein the motor control unit reduces the peak voltage of the input power to the motor and reduces the current delivered to the motor dynamically to optimize efficiency of the motor.

9. The power generation system of claim 8 wherein the high-efficiency is a three-stage generator that includes a rectifier stage outputting DC power through three pairs of output terminals, and wherein the output interface includes an inverter stage to convert the DC power to AC power for use by the output devices.

10. The power generation system of claim 8 wherein outputs AC power at a frequency range of 20 KHz to 40 KHz, and wherein the output interface includes an converter stage to downconvert the AC power to one of 50 Hz or 60 Hz for use by the output devices.

11. The power generation system of claim 2 wherein the switch is coupled to a plurality of devices, some of which are alternating current type and some of which are direct current type devices, and wherein the switch is configured to route the appropriate type of electrical power to the corresponding device type.

12. A power generation system comprising:
an input interface receiving power from a power source;
a high efficiency generator coupled to the induction motor;
an output interface coupled to the high efficiency generator; and
a control unit coupled to the input interface and the output interface.

13. The power generation system of claim 12 further comprising a switch coupled to the output interface, the switch configured to provide power output from the output interface to one or more of a plurality of output devices.

14. The power generation system of claim 13 wherein the output devices are selected from the group consisting of: electrical devices, battery storage elements, and a utility meter system for feeding a power grid.

15. The power generation system of claim 12 wherein the power source produces kinetic energy.

16. The power generation system of claim 15 wherein the power source is selected from the group consisting of: wind energy, water energy, compressed gas energy, and internal combustion engine energy.

17. The power generation system of claim 13 wherein the switch is coupled to a plurality of devices, some of which are alternating current type and some of which are direct current type devices, and wherein the switch is configured to route the appropriate type of electrical power to the corresponding device type.
